(19) United States
(12) Patent Application Publication
(10) Pub. No.: US 2013/0281114 A1
(43) Pub. Date: Oct. 24, 2013

(54) METHOD, SYSTEM AND DEVICE FOR POSITIONING A MOBILE TERMINAL

(71) Applicant: STARBERRY LIMITED, Hong Kong (CN)

(72) Inventors: Wing-fung YU, Hong Kong (CN); Jason Felix Tsz-kiu CHIU, Hong Kong (CN)

(21) Appl. No.: 13/763,275

(22) Filed: Feb. 8, 2013

(30) Foreign Application Priority Data
Feb. 10, 2012 (CN) CN201210030372.X

(51) Int. Cl. H04W 4/02

(52) U.S. Cl. CPC H04W 4/02
USPC 455/456.1

(57) ABSTRACT

A method, system and device of device of terminal positioning in the field of communication technology is disclosed. The method including the following steps of a signal-receiving-end receiving a sound wave signal indicating the position of a signal-sending-end, the signal having been sent by the signal-sending-end which is within the same region. It is possible to obtain the current position information of signal-receiving-end in accordance with the signal to position the terminal in indoor environments and near the building-intensive outdoor environments.

### FIELD OF THE INVENTION

This invention relates to a field of communication technology. More particularly, this invention relates to a method, a system and a device for positioning a mobile terminal.

### BACKGROUND OF THE INVENTION

With the development of communication technology, a user can determine the position of a device, or a terminal, via a number of communication technologies. For example, a terminal's position outdoors can be detected using the GPS (Global Positioning System).

This allows mobile devices to identify their positions by using the GPS via satellite signals. However, the GPS is more accurate outdoors or in open areas where satellite signals are unhampered. In an indoor area or within an area densely surrounded by buildings, the GPS usually fails to provide sufficiently precise positioning as satellite signals are either weakened or hampered.

Therefore, if a mobile device is placed in an indoor area or an area surrounded by dense buildings, the GPS will fail to provide accurate positioning.

Accordingly, the current terminal positioning technology is wanting and improvements are desirable.

### SUMMARY OF THE INVENTION

In a first aspect, the invention proposes a method of terminal positioning, comprising the steps of: providing a signal-sending-end, providing a signal-receiving-end, the signal-sending-end sending a signal indicating the position of the signal-sending-end, the signal-receiving-end receiving the signal, obtaining the position information on the signal-receiving-end from the signal.

Typically, the signal is a sound wave. Preferably, the sound wave has a frequency beyond the audible range of the human ear. More preferably, the frequency is high beyond the audible range of the human ear. Alternatively, the frequency is low beyond the audible range of the human ear. Use of sound waves offers the advantage that existing mobile phones, computers or devices with microphones or other sound receiving features immediately used as part of the system.

Preferably, the signal-receiving-end includes a monitor-end, the method further comprising the steps of: the signal-receiving-end transmitting the signal to the monitor-end, and the monitor-end obtaining position information from the signal on the signal-receiving-end.

Preferably, the method further comprises the steps of: providing a query terminal,

the query terminal querying the monitor-end for position information on the signal-receiving-end.

Typically, the signal-receiving-end is a mobile communication terminal, the signal-sending-end is a fixed-device set within the same region, wherein the same region means the effective range of the signal sent by the signal-sending-end.

Preferably, the signal is a non-audible frequency sound wave or radio signal, and

the same region being in an indoor environments and/or near a building-intensive outdoor environment.

Preferably, the non-audible frequency signal is sent in a default first frequency, or

the non-audible frequency signal is sent as a first set of multi-bit information corresponding to the first set frequency, and the radio signal is sent in a default second frequency.

Preferably, the first frequency corresponds to a first-position-coding, the first-position-coding indicating position information in the region, a first set multi-bit information indicating the position information in the region, and a second frequency corresponding to the second-position-coding of default, the second-position-coding indicating the position information in the same region.

Preferably, the first-position-coding, the multi-bit information and the second-position-coding respectively correspond to position information in a position query table, and the method further comprises the step of: the related position information of the first-position-coding, the first set multi-bit information or the second-position-coding obtaining position information via querying the query table.

Preferably, the query table is stored in the signal-receiving-end, the server side network that the signal-receiving-end belongs to, or the monitor-end of the signal-receiving-end. Preferably, the ranges of the first frequency or the first set of frequency is 17000 Hz˜22000 Hz and/or 16 Hz˜25 Hz, and the range of the second frequency is 136 Hz˜174 Hz.

Preferably, the method further comprises obtaining the position information of the signal-receiving-end from signal via decoding the first set frequency to obtain the first set multi-bit information.

Preferably, the signal of position information of the signal-receiving-end is sent after the encrypting the signal-sending-end, and obtaining the current position information of the signal-receiving-end from the signal, the decrypted signal providing information on the position of the signal-receiving-end after decrypting the encrypted signal.

In a second aspect, the invention proposes a system of terminal positioning, comprising: a signal-sending-module which is set in a signal-sending-end, capable of sending a signal indicating position information of the signal-sending-end to a signal-receiving-end within the same region, a signal-receiving-module, which is set in the signal-receiving-end, capable of receiving the signal, a position-information-obtaining-module, which capable of obtaining position information on the signal-receiving-end using the signal.

Preferably, the position-information-obtaining-module comprises: a first obtaining sub-module, which is set in the signal-receiving-end, used for obtaining the current position information of the signal-receiving-end in accordance with the signal, or the position-information-obtaining-module comprises: signal transmitting sub-module, which is set in the signal-receiving-end, used for sending the signal to the monitor-end of the signal-receiving-end, and a second obtaining sub-module, which is set in the monitor-end, used for obtaining the current position information of the signal-receiving-end in accordance with signal.

Preferably, the system further comprises: query module, which is set in the query terminal, capable of querying the monitor-end for position information on the signal-receiving-end.

Preferably, the signal-sending-end is a fixed-device set within a same region, the same region meaning the effective range of the signal of the signal-sending-end, and

the signal-receiving-end is a mobile communication terminal.

Preferably, signals sent by the signal-sending-module are sound waves in a non-audible frequency, or radio signals, the region being within indoor environments and/or areas near the building-intensive outdoor environments.

Preferably, the non-audible frequency sound wave is sent in a default first frequency, or the non-audible frequency signal is sent in accordance with the related frequency of default of the first set multi-bit information, the radio signal is sent by a default second frequency, the same region is the region in an indoor environment and/or near the building-intensive outdoor environment, such as in a suite or a room, or between many building-intensive regions.

Preferably, the first frequency corresponds to a first-position-coding,

the first-position-coding indicating a position in the same region,
the first set multi-bit information indicating the position within the same region,
the second frequency corresponds to a second-position-coding, the second-position-coding indicating the position information within the same region.

Preferably, the first-position-coding, multi-bit information or the second-position-coding respectively corresponds to one position information of the query table, and the position-information-obtaining-module also comprises: a query sub-module, which is set in signal-receiving-end or the monitor-end of signal-receiving-end, capable of querying for the position of the first-position-coding, the first set multi-bit information or the second-position-coding to obtain the position information of the same region.

Preferably, the query table of position information is stored in the signal-receiving-end, or the server side network that the signal-receiving-end belongs to, or the monitor-ends of the signal-receiving-end.

Preferably, the ranges of the first frequency and the first set of frequency are 17000 Hz˜22000 Hz and/or 16 Hz˜25 Hz, and the range of the second frequency is 136 Hz˜174 Hz.

Preferably, the signal-sending-module comprises: a control sub-module used by the first set of multi-bit information to control a sound generating sub-module producing a sound wave of the first set of frequency, a sound generating sub-module, which is used for producing a sound wave of the first set of frequency, a position-information-obtaining-module which comprises a decoding sub-module, which is used for decoding the first set of frequency to obtain the first set of multi-bit information.

Preferably, further comprises: an encryption module, which is set in the signal-sending-end, capable of encrypting the signal of position information of the signal-sending-end, a decryption module, which is set in the signal-receiving-end or the monitor-end of the signal-receiving-end, capable of decoding the signal encrypted by the encryption module.

Preferably, the system includes several signal-sending-modules and/or several signal-receiving-modules, several signal-sending-modules are respectively set in several signal-sending-ends,

several signal-receiving-modules are respectively set in several signal-receiving-ends.

Preferably, the several signal-sending-ends are respectively set in several different regions, as well as the signal-sending-modules in the signal-sending-ends within several different regions send different frequencies of signals.

In yet a further aspect, the invention provides fixed-devices of signal-receiving-ends of systems as mentioned.

In yet a further aspect, the invention provides fixed-devices of signal-sending-ends of systems as mentioned.

Therefore, the invention provides the possibility of setting signal-sending-ends in multi specific regions in an indoor environment and/or near the building-intensive outdoor environment, such as in a suite or a room, or between many building-intensive regions.

From the one frequency or one set of default frequencies, information of the position of the signal-receiving-end in an indoor environment and/or the areas near the building-intensive outdoor environment may be obtained. The signals could be non-audible frequency sound wave signals or radio signals. Non-audible frequency signals include ultrasound signals. The transmission of such signals is stable.

The selection of the suitable frequency may be made according to the specific indoor environments and the device to gain a precisely accurate position. Besides, the monitor-ends of signal-receiving-ends of system could monitor signal-receiving-ends, other query terminals could also inquire monitor-ends about the position information of signal-receiving-ends. This invention could be widely used and to position the terminals to obtain the position information according to different needs.

### BRIEF DESCRIPTION OF THE DRAWING

FIG. 1 is the first embodiment of such invention provides a chart of the system of the terminal positioning.

FIG. 2 is the second embodiment of such invention provides a chart of the system of the terminal positioning.

FIG. 3 is the third embodiment of such invention provides a chart of the system of the terminal positioning.

FIG. 4 is the fourth, fifth and sixth embodiments of such invention provide a chart of the system of the terminal positioning.

FIG. 5 is the seventh embodiment of such invention provides a flow chart of method of the terminal positioning.

FIG. 6 is an embodiment of such invention provides an application diagram of the system of the terminal positioning.

### DETAILED DESCRIPTION OF THE INVENTION

In order to understand the objects, technologies and advantages of such an invention further, the following illustrates embodiments of the invention progressively, with references to drawings. It should be understood that the embodiments and drawings are do not serve to indicate any specific limitation to the invention.

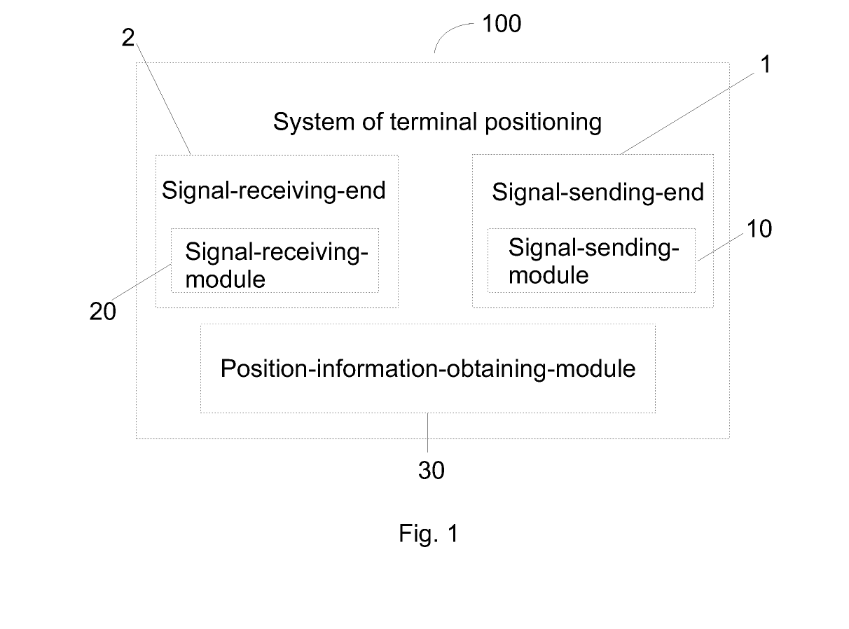

FIG. 1 illustrates a first embodiment, which is a system 100 for positioning a terminal, i.e. locating the position of a device. The system 100 comprises a signal-sending-module 10 located in a position known as “the signal-sending-end” 1, a signal-receiving-module 20 located in a “signal-receiving-end” 2, and a position-information-obtaining-module 30.

The signal sent from the signal-sending-module 10 is a sound wave. The signal-receiving-end 2 is any device capable of receiving the sound wave from the signal-sending-end 1, such as a mobile phone, in which case the signal-receiving-module 20 is the microphone in the mobile phone. In operation, the signal-sending-module 10 sends a signal which indicates the position of the signal-sending-end 1. The signal-sending-end 1, signal-receiving-end 2, and position-information-obtaining-module 30 are all within a predetermined range, such that the signal-receiving-end 2 has to be within the range to detect the signal from the signal-sending-end 1. When the signal-receiving-module 20 receives the signal, the position-information-obtaining-module 30 deduces the position of the signal-receiving-end 2 from the signal.

Preferably, although not necessarily, the sound wave is in a frequency non-detectable by human ear. Such frequency can be higher or lower than the frequency within the audible range to the human ear.

Thus, a mobile phone is able to determine its position by detecting a sound wave indicating the position of the transmitter of the sound wave. As the mobile phone is only able to pick up the sound wave if the mobile phone is within a specific range, the position of the sound wave transmitter may be taken to the position of the mobile phone in some embodiments.

As mobile phones come with a microphone for picking up sounds, it is possible to deploy the embodiment using mobiles phones of users without much difficulty. Whereas if electromagnetic waves or other forms of signals are used as the signals, it may be less convenient than using sound waves, since mobile phones may not have the necessary antennas for the type or range of these other signals.

In general, the system 100 has at least one signal-sending-module 10, at least one signal-receiving-module 20 and at least one position-information-obtaining-module 30. However, where there are several signal-sending-modules 10 and several signal-receiving-modules 20, the several signal-sending-modules 10 are located in several respective signal-sending-ends 1 in different regions. A ‘region’ may be an indoor area such as a suite or a room, or an area surrounded by dense buildings.

Preferably, the signals sent by the signal-sending-modules 10 in these different signal-sending-ends 1 are in different frequencies, to reduce the chance of accidental overlapping signals confusing the signal-receiving-modules 20.

Typically, the signal sending end 1 is a fixed-device. The signal-receiving-ends 2, being mobile devices, may be moving between the different regions.

In an indoor area, the non-audible frequency sound wave signal can be received only by signal-receiving-ends within the same area as the signal-sending-end 1. Signal-receiving-ends in adjacent rooms generally cannot receive the signal due to walls and partitions blocking transmission of the signal thereto.

Similarly, in an area surrounded by dense buildings, the signal from the signal-sending-module 10 located can be received only by a signal-receiving-end 2 within the same area, as the signal will be blocked by the surrounding buildings from reaching adjacent areas.

In a variation of the embodiment, it is possible to define sub-regions within a large region surrounded by dense buildings. One way is to use sound waves of different frequencies, each receivable only within a specific range of distance from a signal-sending-end 1, i.e. a transmitter. Such sound waves are useable in areas between any two buildings which are higher than 30 storeys. The different frequencies prevent interference of signals between different sub-regions.

Therefore, the embodiment uses non-audible sound waves containing information on the position of the signal-sending-end 1, and to determine the position of the signal-receiving-end 2 within range. This allows the position of a mobile terminal such as a mobile phone to be determined in a confined area, where GPS satellite signals cannot reach.

The non-audible frequency sound wave signal is preferably an ultrasound signal, but it may also be a low frequency signal. Typically, an ultrasound signal is above 20000 Hz, whereas a low frequency signal is between 16 Hz-25 Hz. Although out of the human ear range, the microphone of a mobile terminal is quite capable of picking up such non-audible frequencies. The skilled man understands, however, that other types of signals suitable for use in indoor environments or near the building-intensive outdoor environments may be used, whether or not the signals are sound waves. For example, a low-frequency radio wave signal can be used in an indoor area.

Accordingly, the embodiment provides the possibility that owners of a mobile terminal may confirm their location by the mobile terminal they carry.

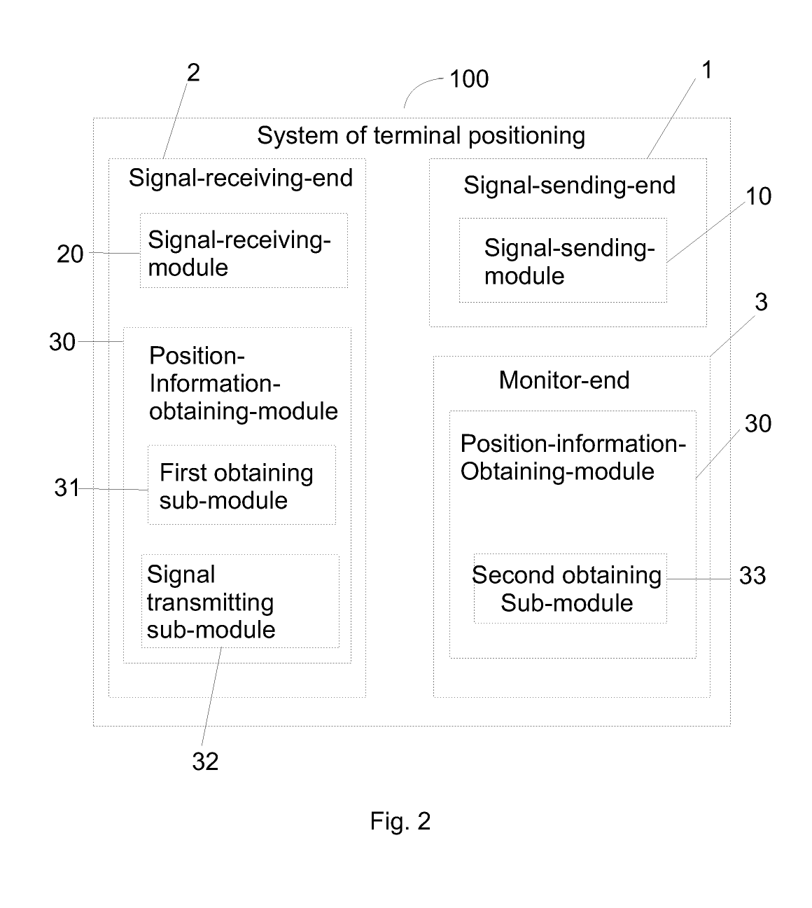

FIG. 2 shows a second embodiment where the position-information-obtaining-module 30 in the signal-receiving-end 2 comprises a first obtaining sub-module 31 used to determine the position of the signal-receiving-end 2 based on the received signal.

In a variation of this embodiment, the position-information-obtaining-module 30 comprises a signal transmitting sub-module 32, which transmits the signal to a monitor-end 3. A second obtaining sub-module 33 is set in the monitor-end 3 for obtaining the position of the signal-receiving-end 2, based on the signal. The monitor-end 3 could be a server side network that the signal-receiving-end 2 belongs to, or could be a server of the system 100.

In other words, the position-information-obtaining-module 30 is set in either the signal-receiving-end 2 (e.g. a mobile device) or the monitor-end 3 (e.g. a monitoring device) of its signal-receiving-end 2, both of which are illustrated in FIG. 2. If the position-information-obtaining-module 30 is set in the signal receiving end 2, the signal receiving end 2 could obtain its current position information from the position-information-obtaining-module 30. Alternatively, if the position-information-obtaining-module 30 is set in the monitor end 3 of the signal receiving end 2, the monitor end 3 could monitor the signal receiving end 2.

Therefore, a mobile device with microphone has been described which can receive a sound wave message from a local sound emitting device, and transfer the position information carried in the sound wave message to the monitoring device. A positioning model in the monitoring device can thereby determine the position of the mobile device. This finds possible application in, for example, a security guard carrying a mobile phone. In the control room, central monitoring system can determine the position of all the security guards each carrying a mobile device, as the mobile device receives sound wave signals indicating the location to the mobile device. Thus, the central monitor has real time knowledge of the whereabouts of all the security guards. This application removes the need of physical positioning reporting points in conventional systems, which is useful only at the moment when the guard hit a button in a reporting point.

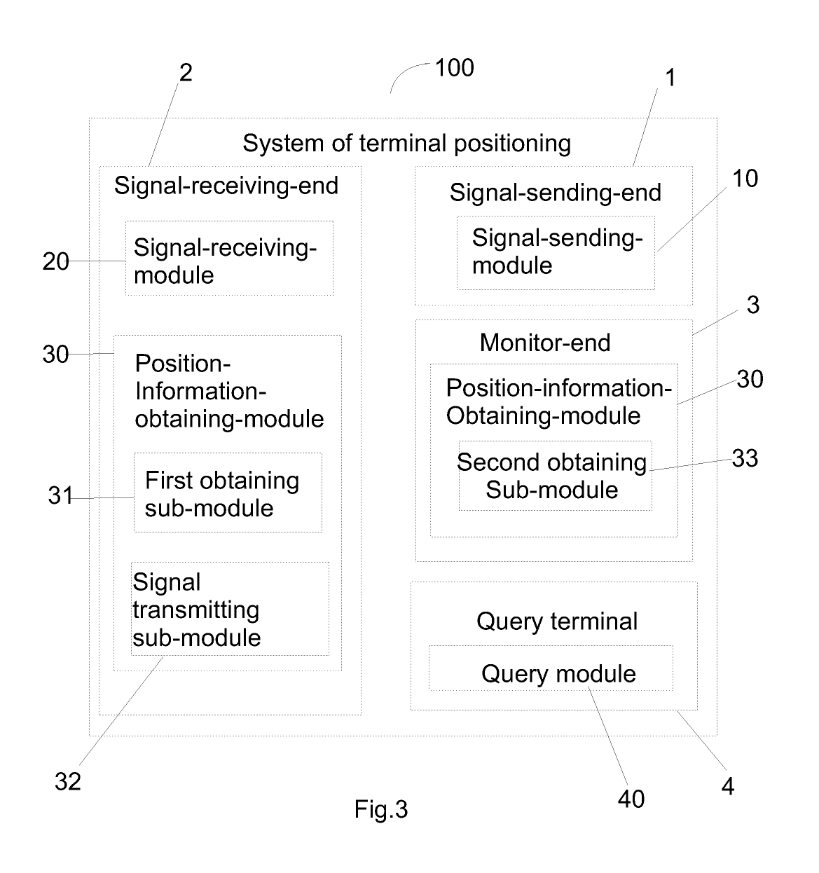

FIG. 3 shows a third embodiment wherein the system 100 further comprises a query module 40 which is set in a query terminal 4, and able to use the monitor-end 3 to query for the current position information of the signal-receiving-end 2.

More specifically, the query terminal 4 queries for the position of the signal-receiving-end 2 via a server side network that it belongs to, or via a communication protocol with the monitor-end 3. This embodiment finds application in Karaoke lounges (KTVs), where the query terminal 4 is used by service attendants and different signal-sending-ends 1 set in different KTV rooms. The signal-receiving-end 2 is a mobile phone or other types of the portable electronic product of a client, and each signal-receiving-end 2 make up a monitor-end 3. Therefore, the attendants can query the monitor-ends 3 to detect the user's mobile phone via query terminal 4, to find out which room is a user in.

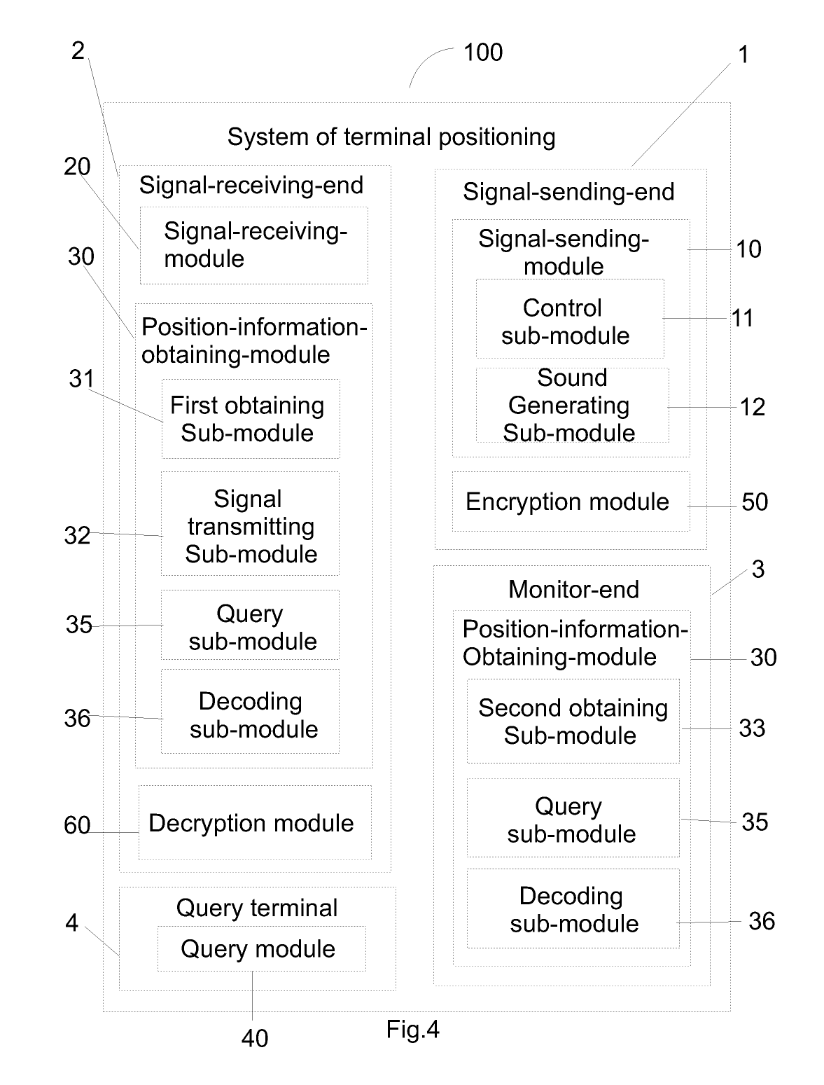

FIG. 4 also shows a fourth embodiment which is based on the third embodiment wherein, the system 100 further comprises an encryption module 50 set in the signal-sending-end 1 and useable for encrypting the signal sent from the signal-sending-end 1. A decryption module 60 in the signal-receiving-end 2 is useable to decode the signal encrypted by the encryption module 50. Alternatively, the decryption module 60 can be placed in the monitor-end 3 of the signal-receiving-end 2. This enhances the safety, confidentiality and precision of the system 100, and such signal cannot be easily tampered by others.

Preferably, the non-audible frequency sound wave signal is sent in a default first frequency, such as in ultra sound or low frequency. Alternatively, the non-audible frequency sound wave signal is sent as a non-audible sound wave in the high and low range, accompanied by radio signals sent in a predetermined second frequency.

The signals sent by signal-sending-ends 1 in different regions, e.g. different rooms, are preferably in different frequencies. This allows the positions of those signal-receiving-ends 2 to be determined accurately. Typically, the first frequency the corresponds to a first-position-coding, where the first-position-coding indicates the position of a region; the first set of frequency corresponds to the first set of multi-bit information; the first set of multi-bit information carries position information in the region; the second frequency corresponds to a default second-position-coding, where the second-position-coding carries position information in the region.

FIG. 4 also illustrates a fifth embodiment, wherein a first-position-coding, a first set of multi-bit information or the second-position-coding corresponds to a query table of positions, and the position-information-obtaining-module 30 comprises: a query sub-module 35, which is set in the signal-receiving-end 2 or the monitor-end 3 of the signal-receiving-end 2, useable for querying the query table of position information about the first-position-coding, the first set of multi-bit information or the second-position-coding corresponding to the position information that would obtain the position information within the same region.

Preferably, the query table is stored in the signal-receiving-end 2, or the server side network that the signal-receiving-end 2 belongs to, or the monitor-end 3 of the signal-receiving-end 2. Thus, the different frequency information or coding information corresponds to the regional position information set by the signal-sending-end to form the query table in advance. After obtaining the signal carrying the position information of the signal-sending-end 1, the current position information of the signal-receiving-end 2 is obtained from the query table.

FIG. 4 also illustrates a sixth embodiment, in which the signal-sending-module 10 comprises: a sound generating sub-module 12, which is useable for producing sound waves in a first set of frequency; a control sub-module 11 useable for controlling the sound generating sub-module 12 to produce the first set of frequency in accordance to the first set of the multi-bit information; a position-information-obtaining-module 30 comprising a decoding sub-module 36, which is used for decoding the first set of frequency to obtain the first set of multi-bit information. The control sub-module 11 is useable to control the sound generating sub-module 12 to produce the first set of frequency in accordance with the first set of the multi-bit information; or making the sound generating sub-module 12 to produce a sound wave in the first frequency. Decoding sub-module 36 would decode the first set of frequency to obtain the first set of multi-bit information.

The control sub-module 11 controls the sound generating sub-module 12 to produce the first frequency or the non-audible frequency of the first set of frequency according to the coding information that is needed to happen, or the default frequency information. Also, when obtaining the position information from the signal-receiving-end 2, the decoding sub-module 36 decodes the first set of frequency and the first set of multi-bit information. Preferably, the first set of frequency is sent as ultrasound signal. Decoding sub-module 36 is stored in the signal-receiving-end 2 or the monitor-end 3. Each piece of multi-bit information corresponds to regional position information in the query table.

FIG. 6 shows an embodiment used in an indoor environment which includes several different “regions”, such as room 1, room 2, room 3 . . . etc. There is a plurality of fixed-devices as signal-sending-ends 1 separated and distributed among the rooms. For example, the first signal-sending-end 1 is set in room 1; the second signal-sending-end 1 is set in room 2; the third signal-sending-end 1 is set in room 3. Each signal-sending-end 1 is disposed to send different information. The first signal-sending-end 1 sends the information ‘000001’; the second signal-sending-end 1 sends the information ‘000010’; the third signal-sending-end 1 sends the information ‘000011’, these pieces of information are coded by non-audible frequency, which means different coding information corresponds to different non-audible frequency.

The decoding sub-module 36 of a signal-receiving-end 2 in Room 1 receives the non-audible frequency sound wave signal by a microphone in the signal-receiving-module 20 of the signal-receiving-end 2, and decodes the non-audible frequency sound wave signal. The decoded information indicates the room that the signal-receiving-end 2 is in via querying the query table. That is, the information ‘000001’ is obtained after decoding and the room is be confirmed as Room 1 according to the query table.

In a bustling city, position coding information is set between high buildings. A signal-receiving-end 2 carried by a user receives the signal from the signal-sending-end 1 in that region and obtain the position-coding-information to confirm the building they are near to. This can be used to allow a lost elderly person carrying a signal-receiving-end 2 to be found, by the position obtainable on query.

Information decoding depends on the frequency of the signal. Thus, the frequency range of the non-audible frequency should be confirmed at first. The lowest frequency in the frequency range could be set as slightly higher than the highest frequency range of human hearing, which is usually 20000 Hz. The highest frequency may be set as the highest frequency range that could be recognized by the signal-receiving-end 2. Preferably, the range of the first frequency and the first set of frequency is 17000 Hz˜22000 Hz, could also be a low frequency signal ranges 16 Hz˜25 Hz. For radio signals, low frequency is preferred. Thus, the range of the second frequency could be 136 Hz˜174 Hz.

Also, the time interval of the non-audible frequency should be confirmed. The time interval could be set to the smallest interval that could be recognized by signal-receiving-end 2. In such embodiment, the non-audible frequency signal is an ultrasound signal. If the smallest frequency interval is 50 Hz, the signal-receiving-end 2 could distinguish between the 20000 Hz non-audible frequency signal and the 20050 (20000+50) Hz.

Assuming that the coding information is ‘100101’, the frequency range is 20000 Hz˜20250 Hz, and the stepped-frequency (time frequency) is 50 Hz when the time interval of the non-audible frequency is 50 Hz, the signal-sending-module 10 would send the acoustic signals of 20000 Hz, 20150 Hz, 20250 Hz etc. The relations between the corresponding multi-bit units of the first set of multi-bit information and the frequencies are as the followings:

TABLE 1

| | |
|---|---|
| first bit unit (1) | 20000 Hz (audible) |
| second bit unit (0) | 20050 Hz (non- audible) |
| third bit unit (0) | 20100 Hz (non- audible) |
| fourth bit unit (1) | 20150 Hz (audible) |
| fifth bit unit (0) | 20200 Hz (non- audible) |
| sixth bit unit (1) | 20250 Hz (audible) |

From table 1, the information applies the six bits for coding. The first bit unit corresponds to frequency 20000 Hz; the first one corresponds to frequency 20050 Hz; . . . the first one corresponds to frequency 20250 Hz. In such embodiment, the first unit is ‘1’, so it would produce an acoustic signal of frequency 20000 Hz. The second unit ‘0’ would not produce any acoustic signals of frequency 20050 Hz. In short, when the bit unit is ‘1’, the corresponding acoustic signal of frequency would be produced. However, when the bit unit is ‘0’, there would not produce any acoustic signals corresponding to the frequency. Besides, the coded information could be sent as ordinary texts, but also as encrypted information to protect such content of information.

Under the circumstances of the frequency directly corresponding to the position information, it could be 20000 Hz corresponding to the position of Room 1 and 20200 Hz directly corresponding to the position of Room 2.

Similarly, lower frequency radio signals could also correspond to different regional position information according to the frequency differences. For example, 140 Hz can be set to correspond to code 000, and code 000 corresponds to the position of Room 1; 145 Hz can be set to correspond to code 0120, and code 012 corresponds to the position of Room 2 etc. Optionally, 140 Hz may be directed to correspond directly to the position of Room 1; 145 Hz corresponding directly to the position of room 2, etc, without needing to be matched to the codes such as 000 or 012.

The signal-sending-end 1 of such device could be set as a fixed-device in the same region; a device of signal-receiving-end 2 could be a mobile terminal or the other fixed terminals. In practice, a software unit, a hardware unit of the combination unit of software and hardware, could comprise the system of terminal positioning 100. The signal-receiving-end 2 could be a mobile, a PDA (Personal Digital Assistant), a Pocket Pc etc.

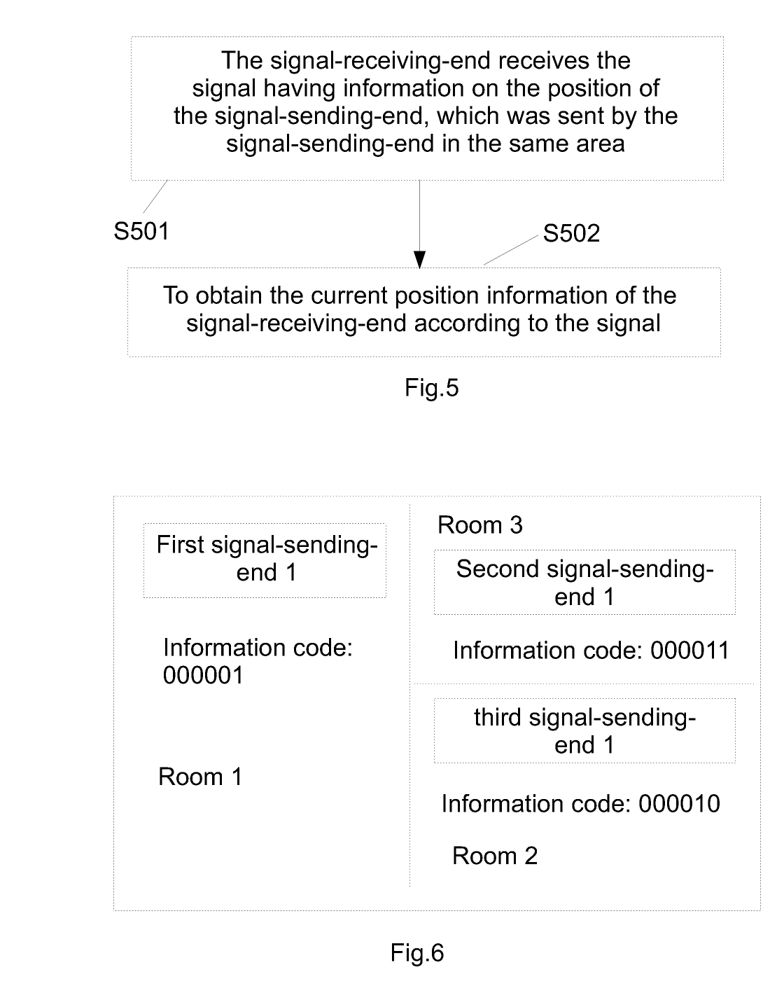

FIG. 5 illustrates a seventh embodiment which offers a method of terminal positioning. The described method would be applied in several systems terminal positioning 100, steps are as followings:
In step S501, the signal-receiving-module 20 of the signal-receiving-end 2 receives a signal marking the position of a signal-sending-end 1 sent by the signal-sending-module 10 of the signal-sending-end 1 within the same region;
In step S502, the position-information-obtaining-module 30 in accordance with the described signal obtains the current position information the signal-receiving-end 2.

In this embodiment, several signal-sending-ends 1 are set in different regions separately. A signal-sending-end 1 is a fixed-device in the same region as a signal-receiving-end 2, in order for the signal-receiving-end 2 to detect the signal. The “region” means an area within the effective range of signals sent by a signal-sending-end 1, and may be an indoor environment, or outdoor areas near the building-intensive environment. The indoor environment could be a suite or a room. The areas near the building-intensive environment could be between many buildings, the front door of a building with higher ceiling, such as a building that is more than 30 storeys, or the area between several high buildings.

Although signal receiving end 2 is described as a mobile communication terminal, it could also be a fixed terminal. Signals sent by the signal-sending-end 1 could be non-audible frequency signals or radio signals.

Step S502 comprises: the first obtaining sub-module 31 of a signal-receiving-end 2 obtaining the current position information of the signal-receiving-end 2 from the signal; or the signal transmitting sub-module 32 of signal-receiving-end 2 transmitting the signal to a monitor-end 3 of the signal-receiving-end 2, the second obtaining sub-module 33 of the monitor-end 3 obtaining the current position information of the signal-receiving-end 2 from the signal.

The second obtaining sub-module 33 of the monitor-end 3 obtains the current position information of the signal-receiving-end 2 from the signal, and may include the following steps: query module 40 of query terminal 4 querying monitor-end 3 for the position of the signal-receiving-end 2.

In one of the embodiments, the obtaining sub-modules set in different positions obtain the position of the signal-receiving-end 2 from the signals sent by the signal-sending-module 10.

In one of the embodiments, the non-audible frequency signal is sent in in a first frequency; or a first set of multi-bit information corresponding to a first set of frequency; and the radio signal is sent in a second frequency. The first frequency corresponds to a first-position-coding, the first-position-coding indicating a position within a region; the first set of multi-bit information indicating a position within a region; the second frequency corresponds to a default second-position-coding; the second-position-coding indicating a position within the region.

Different signal frequencies are pre-determined to correspond to different positions in different regions. This information could be pre-stored in a query table. The first-position-coding, multi-bit information and the second-position-coding are all pre-stored in the query table; the position-information-obtaining-module 30 queries the query sub-module 35 for the corresponding position information of first-position-coding, the first set of multi-bit information or the second-position-coding to obtain the position information within the same region via the query table. After that, the first obtaining sub-module 31 or the second obtaining sub-module 33 obtains the position information of signal-receiving-end 2 in accordance with the position information inquired by the enquiry sub-module 35. Via the frequency signals obtained by the signals received by the signal-receiving-end 2, or the multi-bit information inquires the query table of position information, the position of the signal-receiving-end 2 is obtained.

In addition, the query table of position information is stored in the signal-receiving-end 2; or the server side network that signal-receiving-end 2 belongs to; or monitor-end 3 of the signal-receiving-end 2 etc. The position code can be hard coded to a location table in a mobile device. Preferably, the table is stored in the server and query to the table would be done in the server so that the position code in the table can be updated dynamically.

In one of the embodiments, the signal-sending-module 10 encodes the signals, which are pending to be sent, by different non-audible frequencies, such as “100101”. Different non-audible frequency signals that are pending to happen would be transmitted to control the sub-module 11, the control sub-module 11 would control the sound generating sub-module 12 to produce the first set of frequency in accordance with the first set of multi-bit information of the default. As the position coding of the signal-sending-end 1 is a multi-bit information representing its multi-bit information in a non-audible frequency, one unit of the bit information is represented by one definite non-audible frequency when the non-audible frequency represents the multi-bit information. The level of one bit unit of the multi-bit information means that whether the non-audible frequency, which is related to the bit unit, would happen. The control sub-module 11 of the signal-sending-module 10 according to the related multi-bit information of the signal-sending-end position 1 would confirm the happened non-audible frequency, it would also transform the pending non-audible frequency according to the IFFT (Inverse Fast Fourier Transform) to match the time domain amplitude of the pending non-audible frequency signals. It would then match the time domain amplitude with the non-audible frequency signal that is pending to send a non-audible frequency to transmit the signal to the sound generating module 12. The sound generating module 12 would then send the produced non-audible frequency signals. On both sides of the signal-receiving-end, the decoding sub-module 36 would calculate the signal amplitude according to the different frequencies of the non-audible frequency signal as they would be recorded by the signal-receiving-module microphone. The algorithm could be completed by FFT (Fast Fourier Transform). Via the FFT algorithm, time domain amplitude would be transformed into frequency domain amplitude to confirm the signal amplitudes under different frequencies. If the frequency amplitude is high, the corresponding bit unit of the frequency would be 1. If the frequency amplitude is low, the corresponding bit unit of the frequency would be 0. Besides, if the information is encrypted, the information should be decrypted at first by related decryption algorithm then to obtain the messages of the information. The ultrasound signals and low frequency signals of the non-audible frequency signal are prior signals. The non-audible frequency signal includes ultrasound signals and/or low frequency signals. Generally, the ultrasound signals are above 20000 Hz, the low frequency signals are 16 Hz˜25 Hz. Using the low frequency signals would not only position the terminal, but also would not cause bad effects to the environment which is unlike the GPS radiation, so it is beneficial to our health.

After processed by the decoding module 36, if the recovered information of the non-audible frequency signal is 100101, the corresponding position of the coding information could be confirmed by using the query sub-module 35 to inquire the query table of position information, to confirm the concrete position of the signal-receiving-end 2 in order to get a accurate indoor position. Meanwhile, the query table could be stored in both hardware and software of the signal-receiving-end 2 or monitor-end 3.

In another embodiment, assuming that the non-audible frequency signal is an ultrasound signal and its lowest frequency is 20000 Hz while the highest one is 21500 Hz and the stepped-frequency is 50 Hz, then the selectable frequency would be (21500-20000)/50+1=30, so each frequency could be coded as a 1 bit signal to write codes by using 31 bit. The positions marked by the coded information could be above 2̂31-1, (the coded information “00 . . . 0” should be omitted as these pieces of information would be workable with the signal-sending-end 1, so it would not transmit any signals). However, the mentioned frequency range and time interval are only an embodiment, which means that the frequency range and time interval are not limited to the mentioned ones. The frequency range could be any device of the non-audible frequency range but only ensuring that the signal-receiving-end 2 could receive those signals. For example, the frequency range of an iPhone device could be set as 17000 Hz˜22000 Hz so as the time interval, which is not limited to 50 Hz, could be set depending on needs.

In one of the embodiments, there is one fixed-device as the signal-sending-end 1 in every room in an indoor environment. Every device marks its room which is the position within the same region, and also means that the region where the fixed-device in is one of the regions of a specific range in the indoor environment. Every device marks different position information. The different position information could be coded by different non-audible frequencies to form non-audible frequency signals having different frequencies (set). In the embodiment, 6 bit codes the position information to position 31 rooms, the concrete relations are shown in Table 2 below:

TABLE 2

| Room | Multi-bit codes |
|---|---|
| 1 | 000001 |
| 2 | 000010 |
| 3 | 000011 |
| . . . | . . . |
| 31 | 111111 |

In another embodiment, the signal marking the signal-sending-end position is sent after encryption by the encryption module 50 of the signal-sending-end 1 in step S501. In step S502, after the decryption module 60 decrypts the signal, the position-information-obtaining-module 30 obtains the current position of the signal-receiving-end 2 from the decrypted signal. Therefore, the information of the signal could be protected via encrypting the signal sent by the signal-sending-end 1.

In conclusion, the embodiments set signal-sending-ends in multi specific regions in an indoor environment and/or near building-intensive outdoor environment, such as in a suite or a room, or between many buildings. The signal-sending-end transmits signals by one or one set of default frequency, the signals are received by a signal-receiving-end which is in the same region of the signal-sending-end.

The frequency or the one set of default frequency indicates the position of the signal-receiving-end in an indoor environment and/or the areas near the building-intensive outdoor environment to position the terminal or device containing the signal-receiving-end. The signals could be non-audible frequency sound wave signals or radio signals. The non-audible frequency signals may be ultrasound signals. The transmission of such signals is stable; a suitable frequency may be chosen according to the indoor environment and the device to gain a precisely accurate position. Besides, the monitor-ends of signal-receiving-ends could monitor signal-receiving-ends, other query ends could also query the monitor-ends about the position information of signal-receiving-ends. The embodiments could be widely used to obtain the position of terminals.

There could be numerous embodiments of the method, system and device of terminal positioning in accordance with this invention. It is understood that the technicians of related field could make related amends and modifications in accordance with this invention but within the spirit and scope of this invention. Thus, the related amends and modifications are to be limited only by the claims as set forth below.

What is claimed is:

1. A method of terminal positioning, comprising the steps of:
providing a signal-sending-end;
providing a signal-receiving-end;
the signal-sending-end sending a signal indicating the position of the signal-sending-end;
the signal-receiving-end receiving the signal; and
obtaining the position information on the signal-receiving-end from the signal.

2. A method of terminal positioning, as set forth in claim 1, wherein the signal is a sound wave.

3. A method of terminal positioning, as set forth in claim 2, wherein the sound wave has a frequency beyond the audible range of the human ear.

4. A method of terminal positioning, as set forth in claim 3, wherein the frequency is high beyond the audible range of the human ear.

5. A method of terminal positioning, as set forth in claim 3, wherein the frequency is low beyond the audible range of the human ear.

6. A method of terminal positioning, as set forth in claim 1, wherein the signal-receiving-end includes a monitor-end, the method further comprising the steps of:
the signal-receiving-end transmitting the signal to the monitor-end; and
the monitor-end obtaining the position information from the signal on the signal-receiving-end.

7. A method of terminal positioning, as set forth in claim 6, further comprising the steps of:
providing a query terminal;
the query terminal querying the monitor-end for position information on the signal-receiving-end.

8. A method of terminal positioning, as set forth in claim 1, wherein
the signal-receiving-end is a mobile communication terminal;
the signal-sending-end is a fixed-device set within the same region; and
the same region means a pre-determined effective range of the signal sent by the signal-sending-end.

9. A method of terminal positioning, as set forth in claim 1, wherein
the signal is a non-audible frequency sound wave or radio signal; and
the same region being in an indoor environments and/or near a building-intensive outdoor environment.

10. A method of terminal positioning, as set forth in claim 9, wherein
the non-audible frequency signal is sent in a default first frequency; or
the non-audible frequency signal is sent as a first set of multi-bit information corresponding to the first set frequency; and
the radio signal is sent in a default second frequency.

11. A method of terminal positioning, as set forth in claim 10, wherein
the first frequency corresponds to a first-position-coding, the first-position-coding indicating a position in the region;
the first set multi-bit information indicating the position in the region;
the second frequency corresponding to the second-position-coding of default; and
the second-position-coding indicating the position in the same region.

12. A method of terminal positioning, as set forth in claim 11, wherein
the first-position-coding, the multi-bit information and the second-position-coding respectively correspond to positions as pre-determined in a query table; and
the method further comprises the step of:
using the first-position-coding, the first set multi-bit information or the second-position-coding to query the query table in order to obtain information on terminal positions.

13. A method of terminal positioning, as set forth in claim 12, wherein
the query table is stored in the signal-receiving-end, the server side network that the signal-receiving-end belongs to, or the monitor-end of the signal-receiving-end.

14. A method of terminal positioning, as set forth in claim 11, wherein
the ranges of the first frequency or the first set of frequency is between 17000 Hz˜22000 Hz and/or 16 Hz˜25 Hz; and
the range of the second frequency is 136 Hz˜174 Hz.

15. A method of terminal positioning, as set forth in claim 10, further comprising
obtaining the position information of the signal-receiving-end from the signal via decoding the first set frequency to obtain the first set of multi-bit information.

16. A method of terminal positioning, as set forth in claim 1, wherein
the signal of position information of the signal-receiving-end is sent after encrypting at the signal-sending-end; and
the decrypted signal providing information on the position of the signal-receiving-end to the signal-receiving-end.

17. A system of terminal positioning, comprising:
a signal-sending-module which is set in a signal-sending-end, capable of sending a signal indicating the position of the signal-sending-end to a signal-receiving-end within the same region;
a signal-receiving-module, which is set in the signal-receiving-end, capable of receiving the signal; and
a position-information-obtaining-module, which capable of obtaining position information on the signal-receiving-end using the signal.

18. A system of terminal positioning, as set forth in claim 17, wherein
the position-information-obtaining-module comprises:
a first obtaining sub-module, which is set in the signal-receiving-end, used for obtaining the current position information of the signal-receiving-end in accordance with the signal; or
the position-information-obtaining-module comprises:
a signal transmitting sub-module, which is set in the signal-receiving-end, used for sending the signal to the monitor-end of the signal-receiving-end; and
a second obtaining sub-module, which is set in the monitor-end, used for obtaining the current position information of the signal-receiving-end in accordance with signal.

19. A system of terminal positioning, as set forth in claim 18, wherein the system further comprises:
a query module, which is set in the query terminal, capable of querying the monitor-end for position information on the signal-receiving-end.

20. A system of terminal positioning, as set forth in claim 17, wherein
the signal-sending-end is a fixed-device set within a same region;
the same region meaning the effective range of the signal of the signal-sending-end; and
the signal-receiving-end is a mobile communication terminal.

21. A system of terminal positioning, as set forth in claim 17, wherein
signals sent by the signal-sending-module are sound waves in a non-audible frequency, or radio signals;
the region being within indoor environments and/or areas near the building-intensive outdoor environments.

22. A system of terminal positioning, as set forth in claim 21, wherein
the non-audible frequency sound wave is sent in a default first frequency; or
the non-audible frequency signal is sent in accordance with the related frequency of default of the first set multi-bit information;
the radio signal is sent in a default second frequency;
the same region is the region in an indoor environment and/or near the building-intensive outdoor environment, such as in a suite or a room, or between many building-intensive regions.

23. A system of terminal positioning, as set forth in claim 22, wherein
the first frequency corresponds to a first-position-coding;
the first-position-coding indicating a position in the same region;
the first set multi-bit information indicating the position within the same region;
the second frequency corresponds to a second-position-coding; the second-position-coding indicating the position information within the same region.

24. A system of terminal positioning, as set forth in claim 23, wherein
the first-position-coding, multi-bit information or the second-position-coding respectively correspond to one position in the query table; and the position-information-obtaining-module also comprising:
a query sub-module, which is set in signal-receiving-end or the monitor-end of signal-receiving-end, capable of querying for the position of the first-position-coding, the first set multi-bit information or the second-position-coding to obtain the position information of the same region.

25. A system of terminal positioning, as set forth in claim 24, wherein
the query table of position information is stored in the signal-receiving-end; or
the server side network that the signal-receiving-end belongs to; or
the monitor-end of the signal-receiving-end.

26. A system of terminal positioning, as set forth in claim 23, wherein
the ranges of the first frequency and/or the first set of frequency is between 17000 Hz˜22000 Hz and/or 16 Hz˜25 Hz; and
the range of the second frequency is 136 Hz˜174 Hz.

27. A system of terminal positioning, as set forth in claim 26, wherein
the signal-sending-module comprises:
a control sub-module used by the first set of multi-bit information to control a sound generating sub-module producing a sound wave of the first set of frequency;
a sound generating sub-module, which is used for producing a sound wave of the first set of frequency;
a position-information-obtaining-module which comprises a decoding sub-module, which is used for decoding the first set of frequency to obtain the first set of multi-bit information.

28. A system of terminal positioning, as set forth in claim 17, wherein the system further comprises:
an encryption module, which is set in the signal-sending-end, capable of encrypting the signal of position information of the signal-sending-end;
a decryption module, which is set in the signal-receiving-end or the monitor-end of the signal-receiving-end, capable of decoding the signal encrypted by the encryption module.

29. A system of terminal positioning, as set forth in claim 17, wherein the system includes
several signal-sending-modules and/or several signal-receiving-modules;
several signal-sending-modules are respectively set in several signal-sending-ends;
several signal-receiving-modules are respectively set in several signal-receiving-ends.

30. A system of terminal positioning, as set forth in claim 29, wherein
several signal-sending-ends are respectively set in several different regions;
the signal-sending-modules in the signal-sending-ends are set within several different regions and send signals of different frequencies.

31. A fixed-device of signal-receiving-ends of systems mentioned according to claim 30.

32. A fixed-device of signal-sending-ends of systems mentioned according to claim 17.
